(19) United States
(12) Patent Application Publication
(10) Pub. No.: US 2006/0116911 A1
(43) Pub. Date: Jun. 1, 2006

(54) Method For Providing A Disease Management Service

(75) Inventors: George P. Tremblay, Loveland, CO (US); Michael R. Kerouac, Charlottesville, VA (US)

Correspondence Address: GEORGE PHANEUE TREMBLAY, 15869 NORTH COUNTY ROAD 25 E, LOVELAND, CO, 80538, US

(73) Assignee: INFORMED CARE, INC., Charlottesville, VA (US)

(21) Appl. No.: 10/904,821

(22) Filed: Nov. 30, 2004

(51) Int. Cl. G06Q 40/00

(52) U.S. Cl. 705/4

(57) ABSTRACT

The present invention generally relates to the field of medical services and more specifically to the area of chronic disease management. It comprises a new method for providing a disease management service which utilizes nurse practitioners to engage in regularly scheduled virtual evaluation and management “office visits” with patients, using off-the-shelf videophones for real-time video and audio communications. As these disease management services are delivered to the patient while he remains in his home, such convenient access to professional health care brings about a much closer monitoring of the patient's condition than would be otherwise practical, enabling clinicians to make necessary therapeutic modifications in a timely fashion. Engaging patients in such regularly scheduled office visits also causes increased compliance with recommended regimens and lifestyle modifications, resulting in overall improved management of the patient's chronic condition. Patients are enrolled into the service primarily through referrals from their primary care physicians who sign a Collaboration Agreement with the chronic disease management service. The Collaboration Agreement extends the continuity of care for enrolled patients by keeping the primary care physician informed at all times on the health status of their patients and involved in all important clinical decisions regarding patients referred to the service. The secure Internet-accessible clinical documentation and information systems used in the disclosed method make possible a multi-office practice were information can be seamlessly shared and patient workloads can be distributed across multiple locations. Clinical office visit services provided under the disclosed method qualify for reimbursement by public insurers and many private insurers. The disclosed method represents a novel form of medical practice whose area of operation and potential patient base is unbounded by geographic location, since patients may engage in virtual office visits while remaining in their homes, and the information technology infrastructure utilized allows the disclosed disease management service to deliver medical care from any location that has phone service and an Internet or network connection available.

### BACKGROUND OF INVENTION

1. Field of the Invention

The disclosed invention relates generally to the field medical practice, and more specifically to the areas of chronic disease management and telemedicine. The term telemedicine refers to the delivery of medical services or information to a site other than that where the health professional providing such medical services or information is located. Inasmuch as many diseases cannot be cured, they are considered chronic and the patient must undergo various forms of therapy for the duration of his life. Various techniques that have been developed in the medical field that are designed to improve the clinical outcomes for patients suffering from chronic diseases are collectively referred to as chronic disease management, or simply as disease management. The method disclosed herein relates to a new kind of medical service that applies telemedicine technology to chronic disease management in a novel way, which overcomes many of the obstacles which have previously hindered the use of telemedicine technology in everyday patient care, and which improves upon existing disease management practices by providing patients a more convenient and effective way to regularly access qualified medical practitioners to help them manage their chronic condition. The disclosed disease management service is designed to integrate and coordinate the continuum of care for patients enrolled in the service.

2. Background of the Invention and Prior Art

The method disclosed herein describes a comprehensive technique for delivering direct patient care that joins together in a novel way, two areas of medical practice; telemedicine and chronic disease management. The disclosed method represents a financially viable business method that also produces superior clinical results as compared to traditional disease management practices.

The historical roadblocks and problems that have hindered the proliferation of telemedicine as a viable treatment tool are well understood. They are:

General lack of third-party reimbursement—Cross-state licensing difficulties for providers

Cost of telemedicine-enabling technology—The difficulty of using complicated telemedicine-enabling technology for both health professionals and patients

Concerns about malpractice liability associated with telemedicine

Traditional physician patient-referral patterns and their desire to retain patients under their care

Concerns regarding confidentiality of patient information

Because of these issues, telemedicine implementations to date rarely involve direct patient care delivered by a individual health provider. Implementations have been for the most part limited to: home monitoring of physiological parameters, military use (where many of the same factors do not apply), demonstration projects, specialty medical imaging telemedicine systems for radiology, and medical specialty consultations between physicians. In short, telemedicine technology to date has been used almost exclusively as a physician-to-physician consultation tool or a clinical information-gathering tool, rather than a physician-to-patient treatment tool.

The method and system disclosed herein addresses all of above-mentioned problems, resulting in a financially viable disease management service business method that integrates direct patient care with telemedicine technology and which dovetails with the efforts of other healthcare entities involved in the care or insured coverage of the patient.

The disclosed method is specifically designed to treat patients who suffer from chronic diseases. Due to the chronic nature of their disease, frequent visits to the office of a medical professional by the patient is typically required to keep the physician abreast of the progress of the disease, so that he may make appropriate treatment recommendations and modifications. These office visits often pose a great difficulty and burden to the patient, who may be significantly debilitated by his disease, and who may even require the use of an ambulance to transport the patient to the appointment. Also, the nature of the modern medical practice makes it difficult to schedule such chronic patients at the frequency they may require to maintain optimum health. Lower reimbursement rates for evaluation and management office visits, particularly from public insurers, cannot sustain the physical overhead and salary requirements of a modern medical practice whose schedule is too heavily loaded with such clinically complex patients. As a consequence of the these factors, patients suffering from chronic disease may not see their primary care physician as frequently as medical guidelines recommend, often resulting in dramatic decline in overall health to the patient, and higher costs to the health system.

The method herein described creates a solution to this problem by allowing the patient to remain in their home during regularly scheduled evaluation and management office visits that are conducted by a qualified nurse practitioner in the employ of the disclosed disease management service. The reduced overhead resulting from using nurse practitioners rather than physicians to conduct evaluation and management office visits, coupled with the elimination of the office space and personnel normally required to physically accommodate patients in a typical medical office, render the described method a financially viable means of providing more frequently scheduled disease management services to patients.

The relationship between a primary care physician and his patient is a carefully guarded one. Physicians are hesitant to refer patients to other clinical providers, if they feel there is a chance they may lose control of the care of their patient. This legitimate concern is addressed in the design of the disclosed method by means of the Collaboration Agreement enacted between the primary care physician and the disclosed disease management service. Under the terms of this agreement, the primary care physician retains control over the care of the patient. The disease management service's nurse practitioners serve as dependable clinical partners to the primary care physician, reporting regularly on the patient's health status and collaborating in his care. Collaborating primary care physicians always have access to current information relating to their patient's condition, and are involved in important decisions relating to the care and treatment of the patient. This creates a consistent continuum of care for the benefit of the patient, and results in a lower overall financial cost to the health system.

While medical practice licenses for physicians are granted on a state-by-state basis, medical practice licenses for nurses and nurse practitioners have intrastate licensing programs in place that make it much simpler to achieve professional licensing in multiple states for nurse practitioners than it is for physicians. In many states, nurse practitioners enjoy similar prescriptive powers as primary care physicians. For most insurers, Evaluation and Management medical services delivered by nurse practitioners are billed at the same rate as for primary care physicians, even though salaries for nurse practitioners are generally much less than those for physicians. Liability insurance for nurse practitioners is considerably less expensive than liability insurance for practicing physicians. The combination of these factors make nurse practitioners the ideal health care professional to deliver telemedical chronic disease management services over a wide geographical area, and additionally provide a basis for a feasible business model for establishing a disease management service such as that herein disclosed.

Potential problems regarding confidentiality of patient information is a primary consideration in the design of the disclosed method. All patient information that is recorded by the nurse practitioners is transmitted using secure encrypted electronic formats, and is securely stored in a central database. The information infrastructure described herein is compliant with the most recent comprehensive governmental regulations concerning confidentiality of patient data. Patients enrolled in the described disease management service must sign a release form before any patient data is shared with other parties and healthcare system.

The invention does not claim any novel technology advancements with relation to the hardware and software that are employed in the described methods and systems used to deliver this service. However, their application in the context of the disclosed method is novel. All of the videophone hardware, computer hardware and computer software used in implementing the disclosed service are based on international standards and are available off-the-shelf, with the exception of the software developed for documenting the patient encounters and analyzing resultant data. This clinical documentation and analysis software is highly specialized and is developed by the disease management service. The readily available videophones used in the service are relatively inexpensive and are as easy to use as a regular telephone; no special skills are required to operate the telemedicine technology. Also, the videophones used require no special phone lines in order to operate. Since there are no restrictions or required specifications regarding videoconferencing hardware employed in the delivery of general telemedicine services, any equipment that meets the subjective standards of the patient and the practitioner can potentially be utilized by the disclosed disease management service, including PC-based videoconferencing.

Several patents have been issued which refer to a centrally located videoconference devise, or to a cart that carries various components of a central videoconferencing station to be used for telemedicine-based encounters. In the invention described herein, distinguishes itself from those patents in that there is no central videoconferencing station at the nurse's location, but rather each nurse practitioner has one (or several) small videophone appliances on his or her desk. Encounters with patients are person-to-person, point-to-point. When a multipoint conference with another caretaker is desired, an off-the-shelf multipoint control unit may also be utilized to establish and conduct such a conference.

In contrast to interventional videoconferencing telemedicine systems that are designed to be used on an ad hoc basis, the described method is not an “emergency” service by nature, but rather is characterized by consistently scheduled office visits between the Nurse Practitioner and the patient. The overall duration of the patient's participation in the disease management service may be from several months to many years. It is well understood that patients who attend regular evaluation and management office visits with a medical practitioner generally realize significantly improved outcomes. For reasons cited herein, such regular office visits are difficult to achieve in the real world. The disclosed method mitigates those factors that inhibit regularly scheduled evaluation and management visits with a qualified health practitioner.

A number of patents have been issued for disease management technology-based systems that collect certain health data elements via various methods and devices, and which then store or analyze the data (or both), and the results are delivered as raw data or formatted reports to various parties involved in the healthcare system. This invention distinguishes itself from these types of previously issued patents, in that what is being claimed is a direct patient care delivery method in which services rendered are billable under standard medical insurance office visit claim codes. As described in the disclosed method, the extensive utilization of secure Internet-accessible central data repositories for creating, analyzing and distributing data serves to make its operation more efficient, enhances its ability to coordinate patient care with other healthcare entities, and also serves to remove the limitation of geographic location since records can be created and accessed from anywhere, services can be delivered from anywhere, and patients can be treated without leaving their own homes.

Traditionally, medical practices that provide direct patient care operate within a set geographical region. This is due to both interstate licensing requirements as discussed above and also to the fact that he medical offices must be convenient for the patient to travel to. Another reason is that the patient's medical records must be available for review when a patient is seen. The vast majority of medical practices still rely on paper-based medical records that are stored and filed in their place of business, close to their examination rooms. While some large multi-state practices do exist, they invariably have separate physical offices located in their various practice locations, so that patients can be seen in person at the office where his records are stored. The disclosed disease management service describes a novel form of medical practice that can deliver chronic disease patient care from any location, irrespective of the location of the patient.

In order to be successful, current state-of-the-art disease management practices ultimately depend on the patient's willingness and ability to attend scheduled appointments with his primary care physician or other specialized healthcare provider. Healthcare demographic statistics show that a large percentage of those suffering from chronic diseases fail to attend such appointments for a variety of reasons. As a result, this segment of the patient population represents a disproportionately large expense to the healthcare system, as these conditions can quickly degenerate into more costly and life-threatening complications if not monitored consistently, and appropriate treatments ordered in a timely fashion. The disclosed method mitigates and overcomes many of the factors that prevent or dissuade patients from attending regular office visits with qualified medical practitioners, since they can regularly attend office visits without leaving their homes, and therefore represents a fundamental improvement over existing practices.

### DETAILED DESCRIPTION

Organizational Structure of the Disease Management Service

The entity which controls or owns the disclosed disease management service may be formed as a corporation, a partnership or any other legal form of organization, as the form of ownership is not relevant to the claims being made herein. Employees of the disease management organization fall generally into four categories: executive, sales, administrative and clinical. As the claims being made in this application relate primarily to the manner of operation and method of providing disease management services, discussion of the operative functions of executives and sales employees is not relevant to the claims, and so will not be discussed here.

Nurse practitioners deliver the clinical “evaluation and management office visit” services that are the primary product of the disclosed disease management service. A licensed physician supervises every nurse practitioner in the employ of the disease management service. These supervising physicians are not necessarily employees of the disclosed disease management service, nor are they necessarily primary care physicians who refer patients to the service. The primary focus in the operation of the service is to maximize the percentage of time nurse practitioners spend on direct patient care, and to minimize the amount of time they must spend on tasks that may be classified as administrative in nature, such as clinical documentation in scheduling for office visits conducted with enrolled patients.

Administrative employees perform a variety of functions to support the delivery of the disease management services. Administrative support functions include; enrollment of patients, scheduling of patients, reminder calls to patients, gathering of various clinical data elements from patients in preparation for their encounter with the nurse practitioner, fielding questions from patients about the services offered, working with patients to resolve technical problems with their videophones, billing for services performed by nurse practitioners, maintenance of information systems, responding to technical and administrative questions from physicians, working with insurance companies, and other miscellaneous tasks.

Location and Configuration of Offices

Since virtually all of the clinical care and administrative functions of the disease management service in the preferred embodiment are computer-based or network-based, there are no restrictions on location of either administrative or clinical offices. The entire disease management service may operate out of a single large office, or it could just as easily and effectively operate out of many widely dispersed offices. The primary requirements for physical plant location and configuration are that high-speed communication lines are available to any disease management service location, and that offices must have sufficient physical security to meet Federal regulations regarding the safety and privacy of clinical patient information. Within any clinical offices of the disclosed service, there must be sufficient semi-private areas with appropriate lighting within the offices for the nurses to conduct their patient visits with a minimum of interference. Since many embodiments of the disclosed method are possible as regards physical configuration and location of offices, there could potentially be separate offices containing executive, administrative, information technology and technical support personnel, but without clinical functions performed in that location.

While the disclosed disease management service could optionally use paper records rather than computerized records in implementing the service, doing so would create additional administrative overhead in managing the records and extracting data from them for the purposes described herein. Using paper records would also require additional administrative personnel at each clinical location to manage the records, which would not be required in computerized records were used. The use of paper records would not limit the geographical area or patient base that could be served by the disclosed service, but it would make it less efficient in its operation and would also require that nurse practitioners have on-site administrative support personnel available to them to manage paper medical charts. Thus, using paper records is within the scope of these claims, however it is not the preferred embodiment since doing so would increase the complexity and cost of providing the service, rendering it less profitable and less convenient for those interacting with the service such as primary care physicians, pharmacists and insurers.

Nurse practitioners who deliver the disease management services, are provided with the appropriate type of videophone hardware required to communicate with their patients, and are also provided with a local area network or Internet-connected computer terminal. Since in its preferred embodiment, the disease management service enables nurse practitioners to operate autonomously without any on-site physical support requirements other than their videophone and computer terminal, they may work out of a variety of settings including an office in their home, or out of an office of the disease management service. When working out of an office of the disease management service, nurse practitioner workstations are typically located in a semi-private cubicle type of environment, in order to minimize environmental background noise and visual distractions during their virtual office visits with their patients.

Videophone Technology

Videophones used in providing the service are installed at both the nurse practitioner's workstation, and also in the patient's home or other location convenient for the patient. Videophones may be of several types, depending on which telephone network services are available at the patient's location. Thus, videophones employed by the service may operate in analog mode for those without digital services, IP-based videophone appliances may be installed where such network services are available to the patient, or PC-based videophones could also be used. The claims made herein do not depend upon any particular type of videophone being utilized in the delivery of the disease management services. Any communication device that can deliver real-time video and audio between the two parties with sufficient subjective image quality can be used.

Patient Enrollment

The primary method for enrolling patients into the disclosed disease management service is through referrals from collaborating primary care physicians. A formal Collaboration Agreement is established between the disease management service and primary care physician. This Collaboration Agreement defines the terms and methods of referring patients into the disease management service, as well as other responsibilities of both parties. Primary care physicians are recruited into this collaborative relationship by a variety of means. The service may employ inside or outside salesman to contact individual physicians, physician groups, physician networks, insurers or other professional groups or organization's in which physicians participate. In this fashion, individual physicians, as well as groups of physicians are recruited and, if they choose to do so, will sign the Collaboration Agreement with the disclosed disease management service. Direct marketing methods targeting primary care physicians such as e-mail, fax, advertisements and targeted mailings may also be used in the recruiting effort.

Patients may also be enrolled into the disease management service through contracts with other types of health care entities. Health networks, health insurers and similar entities may engage the disease management service to provide care to a subset of their chronic disease population. Primary care physicians of patients referred to the service in this manner are contacted by the disease management service regarding their participation in the care of their patient, and are offered the opportunity to sign the Collaboration Agreement with the disease management service. If they choose to do so, the structure and terms will be in place for the referral of other patients under the care of the primary care physician.

Individual patients may also elect to enroll in the disease management service of their own volition. Individual patients may be recruited by several means including but not limited to: mass mailings, Internet marketing, e-mail campaigns and television advertisements. When individual patients are successfully enrolled into the disease management service, their primary care physicians are contacted by a salesperson. The benefits of the service are then presented to the physician, and he is asked at that time to sign the Collaboration Agreement with the disease management service.

Collaboration Agreement

The Collaboration Agreement defines the working relationship between the disclosed disease management service and primary care physicians or other healthcare providing entities that refer patients to the disease management service. The collaboration agreement features the following provisions:

The Collaboration Agreement defines the methods and processes to be used for referral of patients to the disease management service by the primary care physician are defined.

The Collaboration Agreement stipulates that the referring physician retains primary control over the health care of any patient he refers to the disease management service.

The Collaboration Agreement stipulates that the primary care physician will be notified and/or consulted if there are any significant changes in patient's health status, or if changes to the patient medication regimens may be necessary.

In the Collaboration Agreement, the disease management service agrees to provide the primary care physician access to clinical documentation generated by the disease management service for patients he has referred to the service.

In the Collaboration Agreement, the primary care physician agrees to periodically review clinical documentation generated by the disease management service for his referred patients.

In the Collaboration Agreement, the disease management service agrees to reimburse the physician for time spent in reviewing the above clinical documentation and for time spent collaborating with the disease management service's nurse practitioners.

Videophone Shipping and Patient Setup

Referred patients from all sources are each telephoned by administrative personnel. In the call, patients are notified that they have been referred to the disease management service by their primary care physician or other health-care provider, and are asked if they are interested in enrolling.

If referred patients decline to enroll, then his referring physician or other referral source is so notified.

If the patient accepts enrollment, then the administrative person initiating the call collects the patient's personal and medical information, and arrangements are made for a videophone to be shipped to the newly enrolled patient. Videophone hardware is provided to enrolled patients free of charge.

After the videophone arrives, the patient may install the videophone himself if he feels he is capable, or he may request help from the technical support personnel at the disease management service. Once the videophone is installed and tested, an administrative person calls the patient to set up an initial virtual office visit with his assigned nurse practitioner.

The patient's participation in the disclosed disease management service may be terminated by his own decision, or by a mutual decision between the patient and his primary care physician. When a patient leaves the disease management program, the videophone hardware is returned to the disease management service.

Scheduling and Clinical Support

In order to maximize the time spent on direct patient care, administrative staff members manage patient schedules for nurse practitioners. Each patient has a nurse practitioner assigned to him at the time he is enrolled. If the primary assigned nurse practitioner is not available for some reason, the administrative staff will temporarily designate another nurse practitioner to care for the patient in his stead. As a reminder for upcoming visits, administrative staff attempts to contact patients ahead of the scheduled appointment. When patients first enroll into the program, they are scheduled for once a week appointments at a specified time and day of the week. As the patient progresses through the disease management program, their scheduled office visits may become less frequent than every week. If the patient reaches a sufficient level of control over their chronic condition, his weekly appointments may scale back to once every two weeks, then possibly to once a month. Patients, or their physicians on their behalf, may elect to exit the disease management service at any time.

Administrative personnel of the disease management service handle all scheduling of nurse practitioner/patient virtual office visits, and place reminder calls to patients for upcoming visits. Specialized software to manage the scheduling function is run on a server that is located in the administrative offices of the disease management service, or may be co-located at another secure location. Nurse practitioners access their schedules using the computer terminal provided by the disease management service. Connections to the scheduling server from these computer terminals may be via a secure local area network connection, or via a secure connection over the Internet. In the scheduling software, nurse practitioners have the ability to adjust their own schedules in the event that a patient may not be available to attend a regularly scheduled office visit.

Videophone Technical Support

Any technical problems that patients may be having with their videophones are reported to the administrative staff by the nurse practitioner. The administrative staff then calls the patient on the phone and attempts to resolve any reported videophone hardware problems. If the problems cannot be resolved, then new videophone hardware is sent to the patient before the next appointment, and the faulty videophone hardware is picked up and returned to the disease management service.

Delivery of Patient Care

When the time for the scheduled appointment with the patient has arrived, the nurse practitioner will call the patient on their videophone. After the patient answers, the video connection is established and the parties can see and hear each other. During the virtual office visit, the nurse will follow standardized protocols in her interaction with the patient. Specific clinical protocols to be used will vary with the diagnosis of the patient. At the conclusion of the office visit, each party will hang up the videophone; the nurse practitioner will finish their clinical documentation for the encounter, and will then call the next scheduled patient and repeat the process.

Standardized Clinical Protocols

Standardized clinical protocols are developed by the clinical staff of the disease management service, and conform to the standards of care for the disease state, or states, that the patient is suffering from. Before seeing patients on behalf of the disease management service, employee nurse practitioners are trained in this specialized telemedicine-based method of healthcare delivery, as well as in the standardized disease-state clinical protocols. The structure and content of these protocols is reflected and embodied in the formal clinical documentation that each nurse practitioner generates at the conclusion of each virtual office visit. Depending on the disease state(s) of the patient being “seen”, appropriate documentation forms are presented to the nurse practitioner on her computer terminal Clinical Documentation In the preferred embodiment, clinical documentation for patient “office visits” is created via a secure connection to a central server that holds the primary clinical databases for the disease management service. All nurse practitioners are provided with computer terminals that allow them to access these clinical databases. An intuitive user interface is provided to the nurse practitioners that enable them to easily review historical medical records of their patients, as well as to create new clinical documentation for their virtual office visits. Common chronic diseases have associated parameters which can be objectively measured, and which are useful to clinicians in gauging the progress of the disease and the health of the patient. Depending upon which disease state is being treated, measurements for relevant parameters are recorded by the nurse practitioners into the clinical databases during their office visit with their patients. Off-the-shelf electronic medical devices may also be utilized to record and transmit data representing various physical parameter measurements, with said data being transmitted to the offices of the disease management service and input into the patient record either by automatic electronic means or by transcription into the database of the transmitted measurements. All of the data and observations generated from nurse practitioner office visits or from medical devices, can be output from the central database as formatted electronic or paper documents which conform to industry-standard clinical documentation for the type of office visit service being provided. Paper or electronic versions of the clinical documentation can then be appropriately communicated to physicians, insurers and other healthcare entities involved in the care of the patient. In the preferred embodiment, physicians are given user names and passwords and access patient documentation via a secure connection to the central database of the disclosed disease management service.

Pharmacist Review and Conference

A primary objective in the design of the disclosed disease management service is to integrate the services it provides with the continuum of care of the patient. In the medical field, the clinician most knowledgeable regarding potential contraindications or appropriateness of the prescription drug regimen for any given patient, is the pharmacist. Patients often see several physicians in the course of their treatment, and they may not correctly report all of their prescriptions to physicians who may be treating them, or medications they have been prescribed. Consequently, unbeknownst to their primary care physician, many patients may be taking a combination of pharmaceuticals that are less than ideal, or that may even be harmful to them. In its preferred embodiment, the disclosed disease management service includes a pharmacist review designed to minimize dilatory effects of contraindicated drug regimens, and to maximize the health benefit of any prescribed regimen for the patient given their diagnosis and current health condition. Once the assigned nurse practitioner has become familiar with the patient's history and has an accurate list of his current drug regimen, a three-way conference between the nurse practitioner, the patient, and a pharmacist may take place. With the permission of the patient, his current drug regimen and relevant medical history is shared with the pharmacist by paper-based or electronic means. As an alternative to a three-way conference, the nurse practitioner may introduce and then refer the patient to the pharmacist, after which the patient and the pharmacist may engage in a one-on-one discussion regarding the patient's condition and medication regimens. Pharmacists who perform this service regularly for enrolled patients of the disease management service will be provided with their own videophones so that they can conduct virtual face-to-face meetings with patients. If the primary care physician for any given patient has signed a collaboration agreement with the disease management service, he will be consulted before any medication changes that may have been recommended by the pharmacist are put into effect.

Working with Primary Care Physicians

Since primary care physicians who have signed Collaboration Agreements are the main source for referrals of patients to the disclosed disease management service, the relationship with them is carefully constructed and managed to keep them constantly updated on the health status of their enrolled patients. A feature of the design of the disclosed disease management service is that the collaborating primary care physician must approve all decisions regarding significant changes in the care and therapies of his patients. This gives the collaborating physician a measure of assurance that he will not lose control of his patient's care. Furthermore, the combination of the physician's knowledge and skill with that of the nurse practitioner works for the benefit of the patient.

Collaborating physicians also receive, or have access to, regular detailed clinical reports on the status of their patients, including visit notes from the encounters between the patient and the nurse practitioner, graphical representations of various health parameters, any medication change requests have been made as well as other reports that may vary according to the particular patient's diagnosis. Collaborating physicians who do not have Internet access will receive these reports in paper format or in electronic media such as CD-ROM. Collaborating physicians who do have Internet access are given password-protected secure access to the central database at the disease management service, with read-only permissions to view medical records for their enrolled patients. For physicians receiving documentation in this fashion, there is no requirement to physically mail them paper or electronic media-based reports.

A key feature of the disclosed disease management service is that collaborating physicians are reimbursed by the disease management service for the time they spend reviewing these records and reports. In the preferred embodiment, Physicians are reimbursed at a fixed rate, which is based on the number of virtual office visit records they review each month. At the end of each period (usually a month) the collaborating physician signs a document stating how many of the nurse practitioner office visit records he reviewed on behalf of his enrolled patients during that month. Upon receiving this document, the disease management service will reimburse the collaborating physician according to the fixed-rate schedule that is included in his Collaboration Agreement. While fixed-rate reimbursement of physicians is used in the preferred embodiment, other methods of reimbursement may also be used within the scope of the claims herein presented.

Billing Insurers for Services

In its preferred embodiment, administrative personnel working for the disease management service perform the task of billing for medical services provided by nurse practitioners. However, the manner and method of billing is not integral to the claims made herein. Documentation generated by nurse practitioners during each virtual office visit is used to determine proper industry standard medical service billing codes to be submitted to insurers for reimbursements. Reimbursements received from insurers for claims submitted are assigned to the disease management service by all employee nurse practitioners. The billing codes used are the same codes that are used for traditional in-person office visits, with the exception that a special add-on telemedicine modifier code may be appended to the normal billing code, where such telemedicine modifier codes are provided by insurers.

What is claimed is:

1. A disease management service method whereby the medical services delivered to patients enrolled in the service consists of evaluation and management “office visits” that are conducted by nurse practitioners, with said office visits being conducted using videophones to enable real-time audio and video communications between the nurse practitioner and the patient, where the patient is situated in his home or other convenient location, and the nurse practitioner is situated at a work location remote from that of the patient.

2. The method of claim 1, whereby the nurse practitioners who provide these evaluation and management office visit medical services on behalf of the disease management service are employees of the disease management service.

3. The method of claim 1, whereby the nurse practitioners who provide these evaluation and management office visit medical services on behalf of the disease management service are supervised by a licensed physician.

4. The method of claim 1, whereby the services rendered to patients enrolled in the disease management service consist of evaluation and management office visits, conducted by nurse practitioners with both patient and practitioner using videophones to enable these office visits.

5. The method of claim 1, whereby patients enrolled in the disease management service are provided with videophones by the disease management service, with said videophones being installed at the patient's home or other location convenient to the patient. Said videophones are provided free of charge to the patient so that he may participate in virtual evaluation and management office visits with remotely located nurse practitioners.

6. The method of claim 1, whereby said videophones are returned to the disease management service by the patient at the termination of their participation in the disease management program.

7. The method of claim 1, whereby the disease management service submits claims for reimbursement for clinical office visit services to both public and private insurers on behalf of its employee nurse practitioners who have provided said office visit services to enrolled patients. These claims for reimbursement are submitted to insurers using the same standard medical industry service coding used for traditional “in person” office visits. In those cases where the insurer also provides for a special add-on telemedicine modifier code, such code is added to the standard medical industry service codes.

8. The method of claim 1, whereby the employee nurse practitioners assign their insurer claim reimbursements for services rendered on behalf of the disease management service, to the disease management service.

9. A disease management service method, whereby the disease management service establishes a formal patient referral and collaborative relationship with primary care physicians or other health-care entity, by means of a Collaboration Agreement.

10. The method of claim 2, whereby the Collaboration Agreement may also be entered by a group of primary care physicians or a healthcare entity other than an individual primary care physician.

11. The method of claim 2, whereby under the terms of the Collaboration Agreement, the methods and conditions of referral of patients to the disease management service by the primary care physician are defined.

12. The method of claim 2, whereby under the terms of the Collaboration Agreement, patients are enrolled into the disease management service through a referral from their primary care physician.

13. The method of claim 2, whereby the Collaboration Agreement stipulates that the referring physician retains primary control over the healthcare of any patient he or she refers to the disease management service.

14. The method of claim 2, whereby the Collaboration Agreement stipulates that the primary care physician of an enrolled patient will be notified and/or consulted if there are any significant changes in patient's health status, or if changes to the patient medication regimens may be necessary.

15. The method of claim 2, whereby under the terms of the Collaboration Agreement, the disease management service provides the primary care physician access to clinical documentation generated by the disease management service relevant to those patients who have been referred to the disease management service.

16. The method of claim 2, whereby under the terms of the Collaboration Agreement, the primary care physician agrees to periodically review clinical documentation generated by the disease management service regarding his referred patients.

17. The method of claim 2, whereby under the terms of the Collaboration Agreement, the disease management service agrees to reimburse the primary care physician for time spent in reviewing the above clinical documentation for his enrolled patients, and for time spent consulting with the disease management service's nurse practitioners on his patients' cases. The rates of said reimbursements are defined within the terms and conditions of the aforementioned Collaboration Agreement.

18. The method of claim 2, whereby utilizing various direct marketing techniques, prospective patients may be recruited directly by the disclosed disease management service. Primary care physicians of successfully recruited patients are then contacted and are asked to sign the Collaborative Agreement.

19. A disease management service method whereby the following functions are conducted over a secure Internet connection, or a local area network connection, to a central database: creation of all new clinical documentation, access to existing clinical documentation by the nurse practitioners and referring primary care physicians, clinical data analysis, patient scheduling functions, management of videophone technical support requests and shipping, billing functions and administrative functions. Internet-connected servers at the primary administrative offices of the disease management service, or other secure location, manage all of the above functions and hold all the clinical and administrative data related to the operation of the disease management service. This feature of the disclosed disease management service enables both the clinical and administrative functions to operate efficiently from multiple geographic locations, and provides a central repository from which data related to the operation of the service can be analyzed and shared with other entities involved in providing health-related services to the patient as described herein.

20. The method of claim 3, whereby each nurse practitioner employed by the disease management service, regardless of their physical location, is provided with a computer terminal. Each of these computer terminals has a secure connection to the central servers of the disease management service, either through a local area network or by secure connections through the Internet. These computer terminals provide nurse practitioners access to all clinical documentation for their patients, which reside in a database on the central servers of the disease management service. Likewise, all new clinical documentation relating to patient encounters is created and updated on the same central database through use of the computer terminals by the nurse practitioners.

21. The method of claim 3, whereby primary care physicians for patients enrolled in the disease management service are given secure Internet access to the electronic medical records of their own patients, thus keeping the primary care physicians abreast of the patient's health status and allowing the physicians to effectively collaborate with the disease management nurse practitioners in the care of the patient.

22. The method of claim 3, whereby when permission is given by a patient, a licensed pharmacist may be given secure Internet access to electronic medical records for selected patients, in order to review their medical history and current medication regimen. In this way, pharmacists can make appropriate recommendations regarding medications and effectively collaborate with the disease management nurse practitioners in the care of the patient.
